(19) United States
(12) Patent Application Publication
(10) Pub. No.: US 2008/0066715 A1
(43) Pub. Date: Mar. 20, 2008

(54) Control of Air-Charge and Cylinder Air Temperature in Engine

(76) Inventor: Mrdjan Jankovic, Birmingham, MI (US)

Correspondence Address: ALLEMAN HALL MCCOY RUSSELL & TUTTLE, LLP, 806 S.W. BROADWAY, SUITE 600, PORTLAND, OR, 97205, US

(21) Appl. No.: 11/532,444

(22) Filed: Sep. 15, 2006

(51) Int. Cl. F02B 3/00; F01L 1/34; F02B 17/00; F02D 13/00

(52) U.S. Cl. 123/302; 123/295; 123/348; 123/90.16

(57) ABSTRACT

A method of operating an engine having at least one cylinder during a homogeneous charge compression ignition is provided. The method comprises: directing a first air stream to the cylinder via a first throttle; directing a second, separate, air stream to the cylinder via a second throttle, said first stream at a higher temperature than said second air stream; regulating a total air flow of a mixture of the first and second streams to a desired value by varying both openings of the first throttle and the second throttle in a same direction; and adjusting compression ignition combustion timing by increasing an opening of one throttle and decreasing an opening of the other throttle.

### FIELD

The present application relates to systems and methods for control of air-charge and cylinder air temperature in HCCI engine and during mode transitions with an internal combustion engine.

### BACKGROUND AND SUMMARY

Internal combustion engines may operate in a variety of combustion modes. One example mode is homogeneous charge compression ignition (HCCI), wherein an air and fuel mixture achieves a temperature where combustion occurs by autoignition without requiring a spark being performed by a sparking device. In some conditions, HCCI may have greater fuel efficiency and reduced NOx production compared to other combustion modes. However, the main challenge in controlling HCCI engine is the combustion timing. In contrast to spark ignition and conventional diesel compression engines where the start of combustion is controlled by spark discharge and start of injection, respectively, the start of combustion in HCCI engines occurs when the temperature and/or pressure of the in-cylinder mixture reach the auto-ignition threshold. Thus, the combustion timing can be controlled through a mechanism that affects in-cylinder gas temperature.

One approach to control both intake flow and temperature is described in U.S. 2005/0183693. In this example, a bifurcated intake manifold is used where one intake manifold supplies cool air to cold intake valve and another intake manifold supplies hot air to hot intake valve to control HCCI combustion. The bifurcated intake manifold is combined with a camless actuator to provide control on HCCI combustion via valve timing.

However, the inventors herein have recognized disadvantages with such an approach. For example, adjusting valve timing alone may not provide desired air-charge and achieve appropriate combustion timing in some conditions. Further, coordination between cold and hot streams may be a control issue.

In one approach, the above issues may be addressed by a method of operating an engine having at least one cylinder during a homogeneous charge compression ignition, comprises: directing a first air stream to the cylinder via a first throttle; directing a second, separate, air stream to the cylinder via a second throttle, said first stream at a higher temperature than said second air stream; regulating a total air flow of a mixture of the first and second streams to a desired value by varying both openings of the first throttle and the second throttle in a same direction; and adjusting compression ignition combustion timing by increasing an opening of one throttle and decreasing an opening of the other throttle.

In this way, the cylinder air-charge may be regulated to a desired value by adjusting both throttles in the same direction (e.g., opening, or closing) in response to regulate airflow (e.g., responsive to MAF errors) while the appropriate combustion timing may be achieved by increasing the opening of one throttle and decreasing the opening of another throttle (e.g., adjusting the throttles in opposite directions).

In one embodiment, the adjusting of throttle positions may be based on a measure of combustion timing, which provides control of combustion in HCCI mode. On the other hand, when desired air temperature is achieved but total air flow needs to be changed, the desired air flow can be obtained by varying the opening of both hot and cold throttles based on feedback from mass air flow sensors and/or combustion feedback. In this way, coordination of the throttles in HCCI mode can provide appropriate control of air temperature, combustion timing and air-fuel ratio. Thus, it is possible to reduce fuel consumption and emissions.

### DESCRIPTION OF THE DRAWINGS

FIG. 1 shows an example engine cylinder configuration.

FIG. 2 shows an alternate view the example engine of FIG. 1.

FIG. 3 shows an alternate view of the example cylinder of FIG. 1.

FIGS. 4 and 5 are graphs showing example intake valve operations.

FIG. 6 shows exemplary strategies to control air charge and combustion timing in HCCI mode through throttle positions.

FIG. 7 shows a block diagram of throttle position regulation system for hot stream control.

FIG. 8 shows an exemplary routine to control combustion in the SI through throttle positions.

FIG. 9 shows an exemplary flow chart describing a control routine for performing transition from SI mode to HCCI mode.

FIG. 10 shows an exemplary flow chart describing a control routine for performing transition from HCCI mode to SI mode.

### DETAILED DESCRIPTION

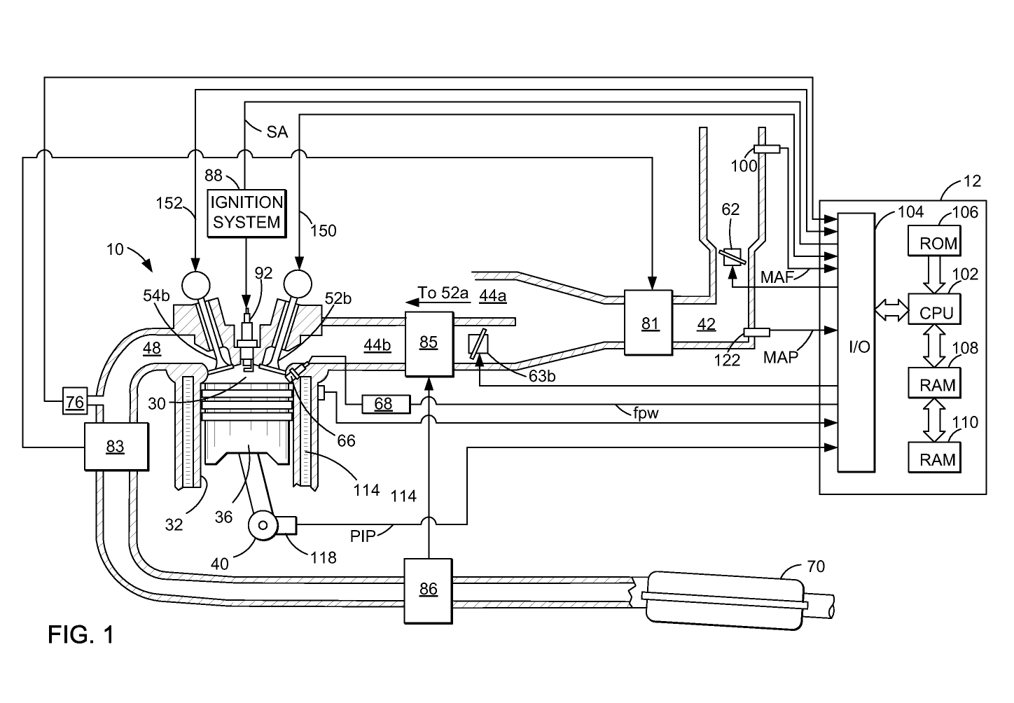

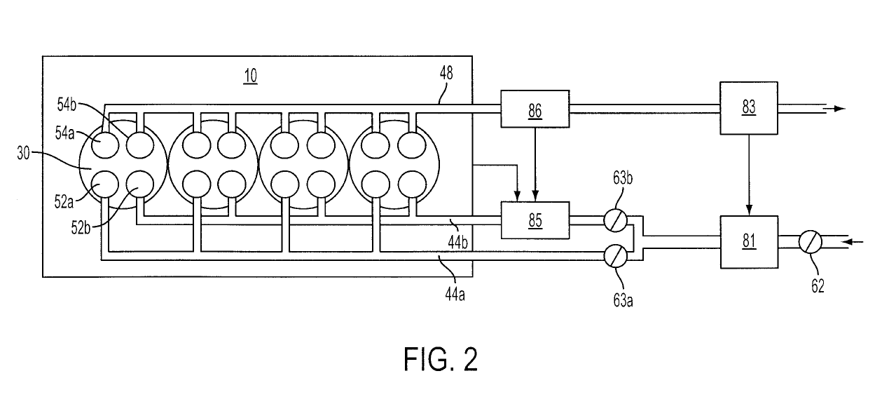

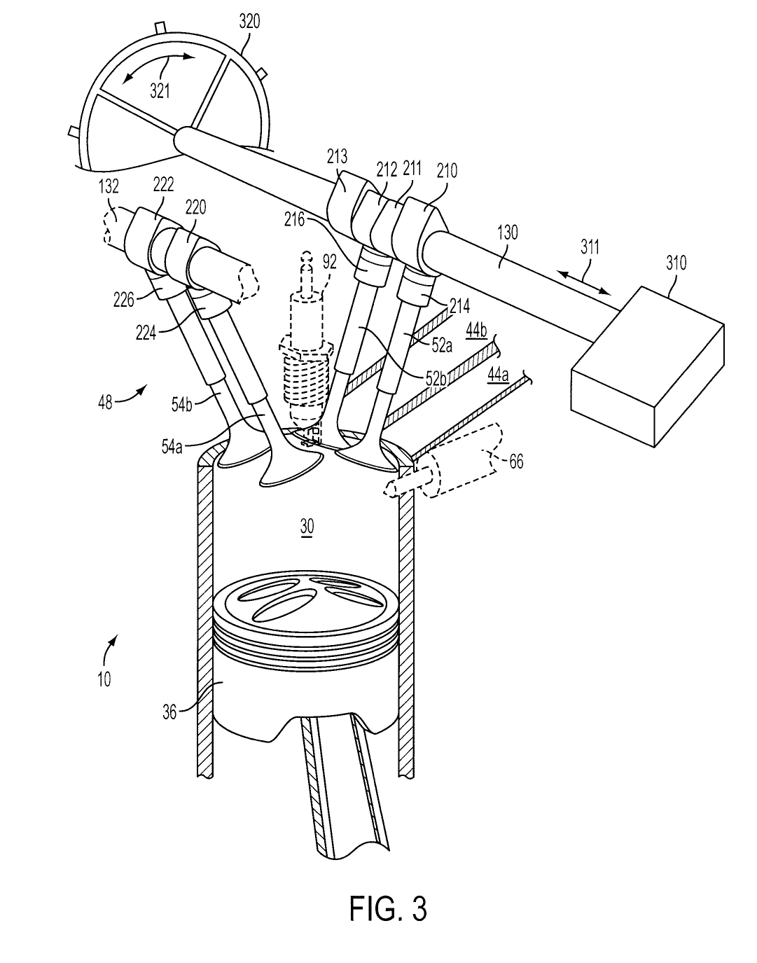

FIG. 1 is a schematic diagram of one cylinder of a multi-cylinder engine, as well as one of the intake and exhaust paths connected to that cylinder. A direct injection internal combustion engine 10, comprising a plurality of combustion chambers, is controlled by a control system including electronic engine controller 12. Combustion chamber 30 of engine 10 is shown including combustion chamber walls 32 with piston 36 positioned therein and connected to crankshaft 40. A starter motor (not shown) may be coupled to crankshaft 40 via a flywheel (not shown). Combustion chamber 30 is shown communicating with intake manifold 44b and exhaust manifold 48 via respective intake valve 52b and exhaust valve 54b. Combustion chamber 30 also may communicate with intake manifold 44a and exhaust manifold 48 via respective intake valve 52a and exhaust valve 54a (shown in FIGS. 2 and 3). As will be described below in greater detail, intake air may be delivered to combustion chamber 30 via valve 52b at a higher temperature than intake air supplied via valve 52a.

Fuel injector 66 is shown directly coupled to combustion chamber 30 for delivering injected fuel directly therein in proportion to the pulse width of signal fpw received from controller 12 via electronic driver 68. The fuel injector may be mounted in the side of the combustion chamber or in the top of the combustion chamber, for example. Fuel may be delivered to fuel injector 66 by a conventional high pressure fuel system (not shown) including a fuel tank, fuel pumps, and a fuel rail.

Intake manifold 42 is shown communicating with main throttle 62. In this particular example, the position of throttle 62 may be varied by controller 12 via an electric motor. This configuration is commonly referred to as electronic throttle control (ETC), which may also be utilized during idle speed control.

Engine 10 may further include a compression device such as a turbocharger, including a compressor 81 arranged along intake manifold 42 and a turbine 83 arranged along exhaust manifold 48. Turbine 83 may supply mechanical work to compressor 81 via a shaft, for example.

Intake manifold 42 is shown branching into intake manifold 44b and intake manifold 44a. Intake manifold 44b may include an electronic throttle 63b as described above with reference to throttle 62. Similarly, intake manifold 44a may include an electronic throttle 63a (shown in FIG. 2). Intake manifold 44b is further shown including an intake heat exchanger 85 configured to provide thermal energy (i.e. heat) to the air flowing through intake manifold 44b. Thermal energy may be provided to heat exchanger 85 by a variety of sources. In one embodiment, as shown in FIG. 1, an exhaust heat exchanger 86 arranged in exhaust manifold 48 may provide thermal energy to heat exchanger 85. In another embodiment, thermal energy may be provided to heat exchanger 85 by hot engine coolant. In yet another embodiment, heat exchanger 85 may receive thermal energy via conversion of electrical energy to heat via an electric resistance heater. In some embodiments, the exhaust manifold may not include exhaust heat exchanger 86. It should be appreciated that in some embodiments, throttle 63b may be located downstream of heat exchanger 85, or engine 10 may not include one or more of throttles 62, 63a, and/or 63b.

Exhaust gas sensor 76 is shown coupled to exhaust manifold 48 upstream of catalytic converter 70. Sensor 76 may be any of many known sensors for providing an indication of exhaust gas air/fuel ratio such as a linear oxygen sensor or UEGO (universal or wide-range exhaust gas oxygen), a two-state oxygen sensor or EGO, a HEGO (heated EGO), a NOx, HC, or CO sensor.

Ignition system 88 provides an ignition spark to combustion chamber 30 via spark plug 92 in response to spark advance signal SA from controller 12, under select operating modes. Though spark ignition components are shown, engine 10 (or a portion of the cylinders thereof) may be operated in a compression ignition mode, with or without spark assist, as explained in more detail below.

Emission control device 70 is shown downstream of exhaust manifold 48. Device 70 may be a three way catalyst, NOx trap, various other devices, or combinations thereof. In some embodiments, engine 10 may include a vapor recovery system enabling recovery of fuel vapors from a fuel tank and/or fuel vapor storage canister via purge control valve to at least one of intake manifolds 44a and 44b.

Controller 12 is shown in FIG. 1 as a conventional microcomputer, including microprocessor unit 102, input/output ports 104, an electronic storage medium for executable programs and calibration values shown as read only memory chip 106 in this particular example, random access memory 108, keep alive memory 110, and a conventional data bus. Controller 12 is shown receiving various signals from sensors coupled to engine 10, in addition to those signals previously discussed, including measurement of inducted mass air flow (MAF) from mass air flow sensor 100; engine coolant temperature (ECT) from temperature sensor 112 coupled to cooling sleeve 114; a profile ignition pickup signal (PIP) from Hall effect (or other type) sensor 118 coupled to crankshaft 40; throttle position from a throttle position sensor; and absolute manifold pressure signal, MAP, from sensor 122. Engine speed signal, RPM, is generated by controller 12 from signal PIP in a conventional manner and manifold pressure signal MAP from a manifold pressure sensor provides an indication of vacuum, or pressure, in the intake manifold. Note that various combinations of the above sensors may be used, such as a MAF sensor without a MAP sensor, or vice versa. During stoichiometric operation, this sensor can give an indication of engine torque. Further, this sensor, along with engine speed, can provide an estimate of charge (including air) inducted into the cylinder. In one example, sensor 118, which is also used as an engine speed sensor, produces a predetermined number of equally spaced pulses every revolution of the crankshaft. Controller 12 may be further configured to control the amount of heat supplied to the intake air passing through heat exchanger 85, the position of electronic throttles 44a and 44b, and the amount of boost provided by compressor 81.

Continuing with FIG. 1, engine 10 is shown with an intake camshaft 130 and an exhaust camshaft 132, where camshaft 130 actuates both intake valves 52a, b and camshaft 132 actuates both exhaust valves 54a, b. The valves can be actuated via lift cam profiles on the camshafts (see FIG. 3), where the lift profiles between the different valves may provide varying lift height, lift duration, and/or timing. However, alternative camshaft (overhead and/or pushrod) arrangements could be used, if desired.

Further, lift height, lift duration and/or timing of valves 52a, b and 54a, b can be varied respectively by various valve control devices responsive to signals from controller 12, based on operating conditions. In some embodiments, valve control devices may include a cam profile switching (CPS) device and/or variable cam timing (VCT) device to provide adjustment of valve operation as will be described below with reference to FIG. 3. These valve/cam control devices may be hydraulically powered, or electrically actuated, or combinations thereof. Signal line 150 can send a control signal to and receive a cam timing and/or cam selection measurement from cam shaft 130. Likewise, signal line 152 can send a control signal to and receive a cam timing and/or cam selection measurement from cam shaft 132.

As described above, FIG. 1 merely shows one cylinder of a multi-cylinder engine, and that each cylinder has its own set of intake/exhaust valves, fuel injectors, spark plugs, etc. However, some or all of the cylinders may share some components such as cam shafts 130 and 132 for controlling valve operation. In this manner, a single cam shaft may be used to control valve operation for two or more cylinders. In an alternative embodiment, a port fuel injection configuration may be used where a fuel injector is coupled to at least one of the intake manifolds for providing port injection, rather than directly to cylinder 30.

Further, in the disclosed embodiments, an exhaust gas recirculation (EGR) system may route a desired portion of exhaust gas from exhaust manifold 48 to at least one of intake manifold 42, 44a, and/or 44b via an EGR valve (not shown). Alternatively, a portion of combustion gases may be retained in the combustion chambers by controlling exhaust valve timing.

Humidity sensing may also be employed in connection with the depicted embodiments. For example, an absolute, or relative, humidity sensor may be used for measuring humidity of the ambient air or intake air. This sensor can be located in one or more of the intake manifolds 42, 44a, or 44b, for example. Also note that humidity may be estimated or inferred based on various operating parameters, such as barometric pressure. Alternatively, humidity can be inferred based on auto-ignition characteristics via adaptive learning. Further, barometric pressure and adaptive learning can be used in combination, and may also be used with sensed humidity values.

Further, combustion sensing may be used in connection with the depicted embodiment. For example, a combustion sensor may be coupled to the cylinder. In one embodiment, a combustion sensor may be a knock sensor coupled to the head of the cylinder. In another embodiment, a knock sensor may be located on the body of the cylinder. In yet another embodiment, a combustion sensor may be a pressure sensor installed inside the cylinder. Information from one or more combustion sensors may determine types/modes of combustion as described below and indicate whether combustion performed is predefined or desired.

The engine 10 may be controlled to operate in various modes, including lean operation, rich operation, and “near stoichiometric” operation. “Near stoichiometric” operation refers to oscillatory operation around the stoichiometric air fuel ratio. Furthermore, the engine may be controlled to vary operation between a spark ignition (SI) mode and a homogeneous charge compression ignition (HCCI) mode. As will be described in more detail below, controller 12 may be configured to cause combustion chamber 30 to operate in these or other modes. Various operating conditions of the engine may be varied to provide different combustion modes, such as fuel injection timing and quantity, EGR, valve timing, valve lift, valve operation, valve deactivation, intake air heating and/or cooling, turbocharging, throttling, etc.

Combustion in engine 10 can be varied by controller 12 depending on operating conditions. In one example, SI mode can be employed where the engine utilizes a sparking device, such as spark plug coupled in the combustion chamber, to regulate the timing of combustion chamber gas at a predetermined time after top dead center of the expansion stroke. In some conditions, during spark ignition operation, the temperature of the air entering the combustion chamber may be controlled to be lower than the temperature of the intake air used for HCCI mode to achieve auto-ignition. While SI combustion may be utilized across a broad range of engine torque and speed it may produce increased levels of NOx and lower fuel efficiency when compared with other types of combustion.

Another type of combustion that may be employed by engine 10 uses HCCI mode, or controlled autoignition (CAI) mode, where autoignition of combustion chamber gases occur at a predetermined point after the compression stroke of the combustion cycle, or near top dead center of compression. Typically, when compression ignition of a pre-mixed air and fuel charge is utilized, fuel is normally homogeneously premixed with air, as in a port injected spark-ignited engine or direct injected fuel during an intake stroke, but with a high proportion of air to fuel. Since the air/fuel mixture is highly diluted by air or residual exhaust gases, which results in lower peak combustion gas temperatures, the production of NOx may be reduced compared to levels found in SI combustion. Furthermore, fuel efficiency while operating in a compression combustion mode may be increased by reducing the engine pumping loss, increasing the gas specific heat ratio, and by utilizing a higher compression ratio.

Referring now to FIG. 2, a schematic diagram of engine 10 is shown. In particular, engine 10 is shown having four cylinders; however, it should be appreciated that the engine may include a different number of cylinders. As described above with reference to FIG. 1, combustion chamber 30 is shown having two intake valves 52a and 52b, and two exhaust valves 54a and 54b. Intake manifold 44a is shown communicating with combustion chamber 30 via intake valve 52a and intake manifold 44b is shown communicating with combustion chamber 30 via intake valve 52b. Intake manifolds 44a and 44b are further shown combining upstream of the throttle to form intake manifold 42.

Engine 10 may include one or more throttles. For example, throttle 62 as described above may be used to control the flow of air through intake manifold 42 via controller 12. Similarly, intake manifold 44a may be configured with throttle 63a and intake manifold 44b may be configured with throttle 63b for controlling the flow of intake air to the cylinders. However, in some embodiments, engine 10 may not include one or more of throttles 62, 63a, and 63b. In yet another alternate embodiment, engine 10 may include an independent throttle for each intake valve of one or more cylinders.

Intake manifold 44b may include a heat exchanger 85 that provides heat to air flowing through intake manifold 44b. Heat may be supplied to heat exchanger 85 by one or more sources. For example, heat may be supplied to heat exchanger 85 via heat recovered by heat exchanger 86 arranged in exhaust manifold 48 and/or engine coolant supplied from an engine coolant system. In this manner, combustion chamber 30 may be configured to receive intake air via two sources, each having substantially different temperatures. Engine 10 may further include a compression device such as turbocharger 80. Turbocharger 80 may include a compressor 81 arranged in intake manifold 42 that is powered by turbine 83 arranged in exhaust manifold 48 via shaft 82.

As shown in FIG. 2, each cylinder of engine 10 may be configured to receive intake air via intake manifolds 44a and 44b. Intake air delivered to the combustion chamber via intake manifold 44b may be heated more than the air delivered via intake manifold 44a by varying the amount of heat supplied to intake manifold 44b via heat exchanger 85. In this manner, the intake air supplied via intake manifold 44a may be cooler than the intake air supplied via intake manifold 44b, at least during some conditions.

As described herein, intake manifold 44a may be referred to as the “cold” intake manifold and intake manifold 44b may be referred to as the “hot” intake manifold, although these labels are simply relative. For example, the cold intake manifold (i.e. 44a) may supply intake air that is hotter than the ambient air temperature, but cooler than the intake air provided by the hot intake manifold (i.e. 44b). Further, as described herein, intake valve 52a controlling the amount of air delivered to the combustion chamber via intake manifold 44a may be referred to as the “cold” intake valve and intake valve 52b may be referred to as the “hot” intake valve.

Several approaches may be used to vary the combined temperature of the air delivered to the combustion chamber (i.e. the initial charge temperature). In one approach, the initial charge temperature may be increased by increasing the relative amount of intake air supplied via intake manifold 44b compared to the amount of intake air supplied via intake manifold 44a, while maintaining substantially the same total amount of intake air. For example, the amount of the hotter intake air provided via the hot manifold may be increased and the amount of cooler intake air provided via the cold manifold may be decreased by the same proportion.

In another approach, the initial charge temperature may be increased by increasing the relative amount of intake air supplied via intake manifold 44b compared to the amount of intake air supplied via intake manifold 44a, while varying the total amount of intake air provided to the combustion chamber. For example, the amount of the hotter intake air provided by the hot manifold may be increased more than the amount of the cooler intake air provided by the cold manifold, thereby increasing the temperature of the initial charge temperature while providing a greater total amount of air to the combustion chamber. Alternatively, the amount of the hotter intake air provided by the hot manifold may be decreased less than the amount of the cooler intake air provided by the cold manifold, thereby increasing the temperature of the initial charge temperature while providing less total amount of air to the combustion chamber.

In another approach, the initial charge temperature may be decreased by decreasing the relative amount of hotter intake air supplied via intake manifold 44b compared to the amount of cooler intake air supplied via intake manifold 44a, while maintaining substantially the same total amount of intake air provided to the combustion chamber. For example, the amount of the cooler intake air provided via the cold manifold may be increased and the amount of hotter intake air provided via the hot manifold may be decreased by the same proportion.

In yet another approach, the initial charge temperature may be decreased by decreasing the relative amount of hotter intake air supplied via intake manifold 44b compared to the amount of cooler intake air supplied via intake manifold 44a, while varying the total amount of intake air provided to the combustion chamber. For example, the amount of the cooler intake air provided by the cold manifold may be increased more than the amount of the intake air provided by the hot manifold, thereby decreasing the temperature of the initial charge temperature while providing a greater total amount of air to the combustion chamber. Alternatively, the amount of the cooler intake air provided by the cold manifold may be decreased less than the amount of the intake air provided by the hot manifold, thereby decreasing the temperature of the initial charge temperature while providing less total amount of air to the combustion chamber.

Further, in some approaches, the initial charge temperature may be adjusted by varying the amount of heat supplied to the hot manifold via heat exchanger 85. For example, the initial charge temperature may be increased without necessarily requiring an adjustment to the amount of air supplied via the hot and/or cold manifolds by increasing the amount of heating provided to the hot manifold via the heat exchanger. Alternatively, the initial charge temperature may be decreased without necessarily requiring an adjustment to the amount of air supplied via the hot and/or cold manifolds by decreasing the amount of heating provided to the hot manifold via the heat exchanger.

It should be appreciated that the amount of air delivered via the hot and cold manifolds may also be further varied by adjusting at least one of valve operation (e.g. lift height, lift duration, valve timing) of intake valves 52a and/or 52b, position of throttles 62, 63a, and/or 63b, and/or the amount of turbocharging provided to the intake manifolds. For example, the amount of air provided to the combustion chamber by an intake manifold may be increased by increasing at least one of lift and/or lift duration for the respective valve. In another example, the amount of air provided to the combustion chamber, for example, by intake manifold 44a may be decreased by adjusting throttle 63a.

FIG. 3 shows a more detailed schematic view of combustion chamber 30 of engine 10 having piston 36 disposed therein. Combustion chamber 30 is shown communicating with intake manifolds 44a and 44b via intake valves 52a and 52b, respectively. In some embodiments, exhaust valves 54a and 54b may share a common exhaust manifold 48, which has been removed in FIG. 3. Combustion chamber 30 may also include a spark plug 92 and a fuel injector 66A for delivering fuel directly to the combustion chamber. However, in alternate embodiments, the combustion chamber may not include spark plug 92 and/or direct fuel injector 66A.

Further, FIG. 3 shows how intake valves 52a and 52b may be actuated by a common camshaft 130 and exhaust valves 54a and 54b may be actuated by a common camshaft 132. However, in an alternate embodiment, at least one of the intake valves and/or exhaust valves may be actuated by its own independent camshaft or other device. Camshaft 130 is shown including two cam profiles per valve, where intake valve 52a may be actuated by cam lobes having profiles 210 and 211 via tappet 214 and intake valve 54a may be actuated by cam lobes having profiles 212 and 213 via tappet 216. While this example shows an overhead cam engine with a tappet coupled to the valve stems, tappets may also be used with a pushrod engine.

As shown in FIG. 3, cam profile 210 may be larger and thus provides greater lift to valve 52a than cam profile 211. Similarly, cam profile 213 may be larger and thus provide greater lift to valve 52b than cam profile 212. In this manner, shaft 130 may be configured with a cam profile switching (CPS) device 310 that enables camshaft 130 to translate longitudinally, thereby causing operation of intake valve 52a to vary between cam profiles 210 and 211, and intake valve 54a to vary between cam profiles 212 and 213. However, other configurations may be used to enable CPS device 310 to switch valve control between two or more cam profiles. For example, a switchable tappet may be used for varying valve control between two or more cam profiles.

Cam shafts 130 and 132 may also include a variable cam timing (VCT) device 320 configured to vary the timing of valve opening and closing events by varying the relationship between the crank shaft position and the cam shaft position. For example, VCT device 320 may be configured to rotate cam shaft 130 independently of the crank shaft to cause the valve timing to be advanced or retarded. In some embodiments, VCT device 320 may be a cam torque actuated device configured to rapidly vary the cam timing. In some embodiments, valve timing such as IVC may be varied by a continuously variable valve lift (CVVL) device.

While not shown in FIG. 3, in some embodiments, cam shaft 132 may also include a CPS device and/or VCT device for varying the operation of exhaust valves 54a and 54b.

Further, cam profiles 210 and 211 are shown arranged such that as camshaft 130 is translated longitudinally in a first direction (e.g. via the CPS device), cam profiles 210 and 212 may be aligned with the corresponding tappets to control the operation of valves 52a and 52b, respectively. Similarly, as camshaft 130 is translated longitudinally in an opposite direction via the CPS device, cam profiles 211 and 213 control the operation of valves 52a and 52b, respectively. In this manner, when intake valve 52a is operated with cam profile 210 having a higher lift and/or longer lift duration than cam profile 211, intake valve 52b may be operated with cam profile 212 having a lower lift and/or shorter lift duration than cam profile 213. Conversely, when intake valve 52a is operated with cam profile 211 having a lower lift and/or shorter lift duration than cam profile 210, intake valve 52b may be operated with cam profile 213 having a higher lift and/or longer lift duration than cam profile 212. As will be described below in greater detail, this configuration of cam profiles can be used to provide control of the initial combined charge temperature and/or the amount of intake air supplied to the combustion chamber, for facilitating transitions between various modes of operation.

While FIG. 3 is described above with reference to one cylinder of engine 10, it should be appreciated that some or all of the other cylinders may be configured as combustion chamber 30. In some embodiments, depending on engine configuration, some or all of the cylinders of engine 10 may share cam shaft 130 for controlling the intake valves and cam shaft 132 for controlling the exhaust valves. Alternatively, in some embodiments, such as with engines having cylinders arranged in a “V” configuration, a first cam shaft may control the intake valves for a first group or bank of cylinders and a second cam shaft may control the intake valves for a second group of cylinders. In this manner, a single CPS device and/or VCT device may be used to control valve operation of a group of cylinders.

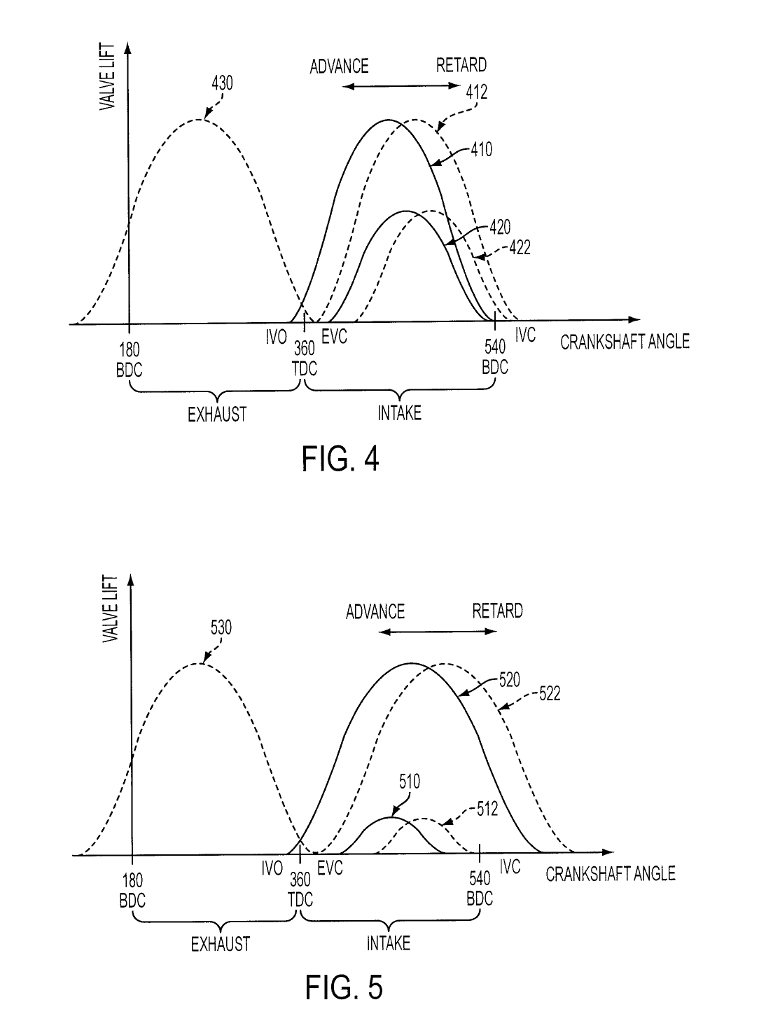

FIGS. 4 and 5 are graphs showing example intake valve operations utilizing the cam profile switching configuration described above with reference to FIG. 3. In particular, FIGS. 4 and 5 show the position of intake valves 52a and 52b with respect to crankshaft angle. The exhaust stroke of the cycle is shown generally occurring between 180 degrees bottom dead center (BDC) and 360 degrees (TDC) crank angle. Subsequently, the intake stroke of the cycle is shown generally occurring between 360 degrees TDC and 540 degrees BDC crank angle.

Further, as shown in FIGS. 4 and 5, a lift of zero or no lift corresponds to a closed position for the intake valves, while a positive lift corresponds to the valve being in an open position, thereby enabling intake air to flow into the combustion chamber. For example, FIG. 4 shows at 410, the lift provided to hot intake valve 52b as controlled by cam profile 213, while at 412, the position of intake valve 52b is shown at a retarded timing relative to 410. The lift provided to cold intake valve 52a as controlled by cam profile 211 is shown, for example, at 420, while the lift provided to intake valve 52a is shown at 422 with a retarded timing relative to 420. Valve timing advance or retard may be provided, for example, by a VCT device described above. Further, an example lift profile provided to the exhaust valves is shown at 430.

In FIG. 4, the hot intake valve 52b is shown having a higher lift and longer lift duration than the cold intake valve 52a. In this condition, the hot intake valve may be referred to as the dominant valve since it may provide the majority of the intake air to the combustion chamber. In this manner, more heated air may be provided to combustion chamber 30 via valve 52b than cooler via valve 52a.

In some examples, the initial temperature of the charge delivered to the combustion chamber may be varied by adjusting the plurality of throttles with or without adjustment of the valve/cam timing between the advanced and retarded positions.

FIG. 5 shows a different selection of cam profiles, for example, as may be performed by the CPS device. For example, the lift provided to hot intake valve 52b as controlled by cam profile 212 is shown at 510, while at 512, the lift provided to intake valve 52b is shown at a retarded timing relative to 510. The lift provided to cold intake valve 52a as controlled by cam profile 210 is shown, for example, at 520, while the lift provided to intake valve 52a is shown at 522 with a retarded timing relative to 520. An example of the lift profile provided to the exhaust valves is shown at 530.

In FIG. 5, the cold intake valve 52a is shown having a higher lift and longer lift duration than the hot intake valve 52b. In this condition, the cold intake valve may be referred to as the dominant valve since it may provide the majority of the intake air to the combustion chamber. In this manner, less heated air may be provided to combustion chamber 30 via valve 52b than cooler air via valve 52a. Furthermore, the low valve lift and/or lift duration provided by cam profile 212 at 510 or 512 may be configured to provide enough air circulation to the combustion chamber so that the air within the hot intake manifold 44b does not become stagnant and cool relative to the desired temperature. In this manner, a ready reserve of heated air may be available for delivery to the combustion chamber.

The example engine configurations described above with reference to FIGS. 1-5 may be used to facilitate transitions between various modes, as well as facilitate control during the various combustion modes. For example, during operation in HCCI mode, it may be desirable to exercise close control over the timing of autoignition. In contrast to a compression ignition operation of a traditional diesel engine, the start of autoignition is not necessarily initiated by the injection of fuel. Further, a spark is not necessarily performed by a sparking device as may be used with an engine configured for spark ignition. During HCCI, the heat release rate may not be substantially controlled by either the rate or duration of the fuel-injection process, as in a diesel engine, or by the turbulent flame propagation time, as in a spark-ignited engine. Therefore, during HCCI mode, the timing of autoignition may be controlled by varying the charge temperature via adjustment of the throttles and/or other parameters, such as valve timing, for example.

During HCCI combustion, autoignition of the combustion chamber gas may be controlled to occur at a desired position of the piston or crank angle to generate desired engine torque, and thus it may not be necessary to initiate a spark from a sparking device to achieve combustion. However, a late spark timing, after an autoignition temperature should have been attained, may be utilized as a backup ignition source in the case that autoignition does not occur, thereby reducing misfire.

As described above, engine 10 may be configured to operate in a plurality of modes. In some embodiments, engine 10 may be configured to selectively vary operation between SI mode and HCCI mode by utilizing the intake valve control methods described above with reference to FIGS. 4 and 5. For example, the intake valve operation shown in FIG. 4 may be used during HCCI mode to provide an initial air charge having a higher temperature for enabling autoignition. During SI mode, the intake valve operation shown in FIG. 5 may be used to provide decreased heating, thereby reducing engine knock and increasing efficiency during SI operation. Transitions between HCCI mode and SI mode may be performed by at least operating the CPS device to vary the intake valve operation between FIG. 4 and FIG. 5, respectively, and adjusting the throttles to provide the desired amount of air at a desired temperature, for example.

The cam profiles 210, 211, 212, and 213 described above with reference to FIG. 3 may be configured such that the compression ratio of the combustion chamber is varied when the cam profiles are switched. For example, when switching from the valve operation of FIG. 4 to the valve operation of FIG. 5, the effective compression ratio may be reduced due to late IVC from approximately 15:1 to approximately 10:1, which would reduce the amount of air delivered to the combustion chamber by approximately a third (⅓). Thus, if the combustion chamber was running at an air/fuel ratio of 30 in HCCI mode, after the cam profiles are switched from 211 and 213 to 210 and 212 for SI mode, the air/fuel ratio would be reduced to approximately 20 for the same amount of fuel and torque. The generally higher air/fuel ratio used during HCCI mode may be to the generally lower air/fuel ratio used during SI mode by switching cam profiles. In this manner, the cam profile switching operation may be used to concurrently vary the charge temperature and the air/fuel ratio. However, it should be appreciated that other cam profiles may be used to provide other changes in compression ratio and/or air/fuel ratio. For example, the cam profiles may be configured to provide more or less change in the effective compression ratio and/or air/fuel ratio. Alternatively, the cam profiles may be configured to provide no change in compression ratio and/or air/fuel ratio (e.g. if cam profiles 210 and 212 are of similar shape, and cam profiles 211 and 213 are of similar shape).

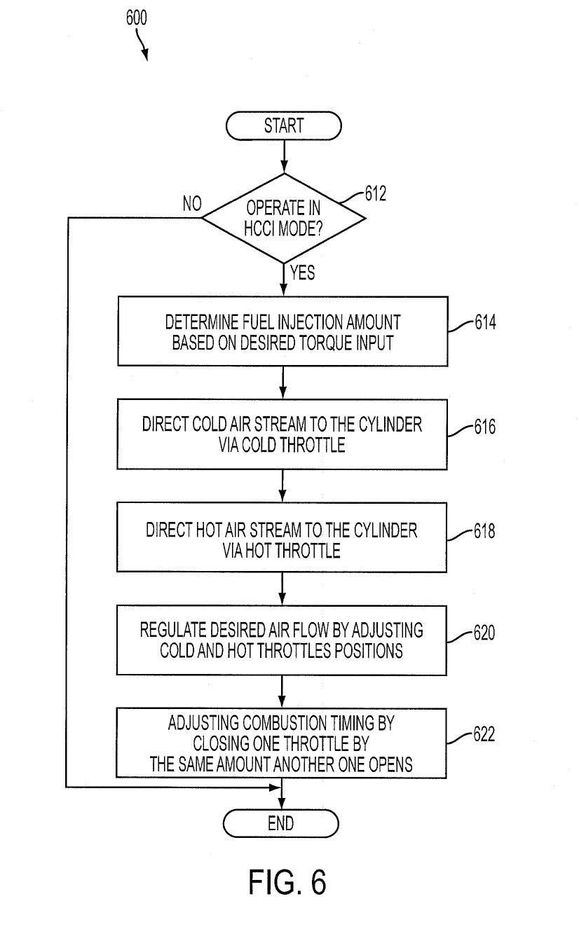

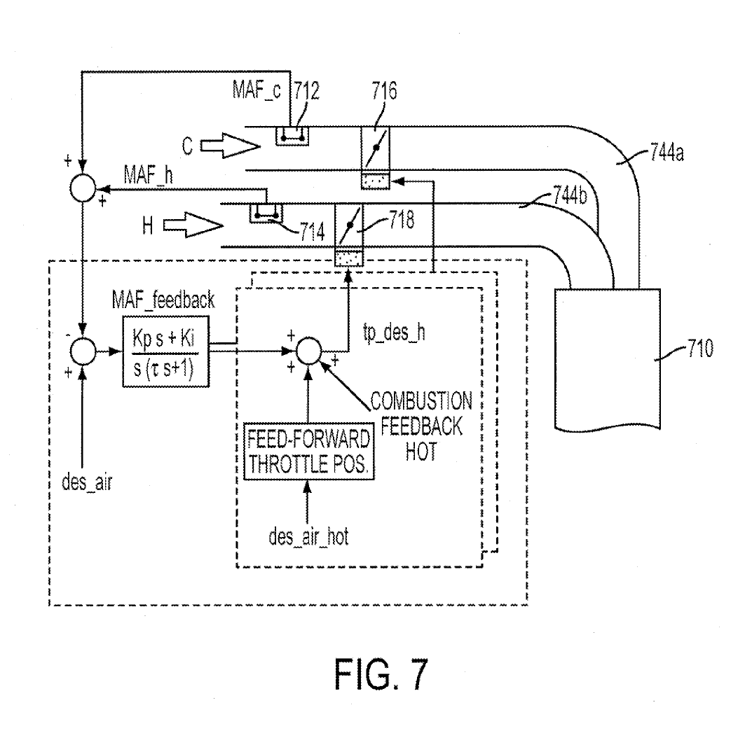

FIGS. 6 and 7 are flowcharts describing example routines for performing control of operation in, and transitions between, SI mode and HCCI mode. In one example, the routines and control approaches described herein may be used to control and/or adjust the throttle openings of at least two air streams of different temperatures to achieve a desired air-temperature, desired combustion timing, and desired air-fuel ratio.

Specifically, FIG. 6 shows exemplary strategies to control air charge and combustion timing in HCCI mode. As described above with reference to FIGS. 1-2, each hot and cold stream may have a dedicated intake port and the intake valve. In HCCI mode, the intake valve profiles may be such that the hot stream is dominant while the cold stream is used to adjust the temperature of the mixture and control the combustion. A possible valve profile is shown in FIG. 4. FIG. 4 also shows the effect of intake cam timing, which could also be used to control the combustion timing. Additionally, adjusting opening positions of the cold throttle which controls air flow of cold stream and the hot throttle which controls air flow of hot stream may be used to achieve the desired combustion timing. In HCCI mode, several components such as fuel, air charge, and combustion timing may be coordinated to achieve the desired response to the driver demand, and selected air-fuel ratio and combustion timing for fuel economy and emission reduction.

In particular, FIG. 6 illustrates an exemplary routine 600 which control combustion through throttle positions in HCCI mode. Beginning at 612, it may be judged whether the engine is operated in HCCI mode. If the answer is no, the routine may end. If the answer is yes, the routine executes a control strategy used in HCCI mode. At 614, the routine determines the fuel injection amount based on a desired torque input, where the desired torque can be affected by a driver demand, vehicle speed, gear ratio, and/or various other parameters. For example, the function between the mass of injected fuel (m_{finj}) and desired torque (des_Tq) may be available from the engine mapping data as:

M_{finj}=Fn_{—}tq2fuel(des_{—}Tq)

### The other fuel related variable, end-of-injection (eoi) timing may be determined based on des_Tq and engine speed N:

eoi=Fn_{—}EOI_{—}hcci(des_{—}Tq, N)

Next, the routine includes directing the cold air stream to the intake valve of the cylinder via the cold throttle at 616 and directing the hot air stream to the intake valve of the cylinder via hot throttle at 618. In some situations, the total air mass in the cylinder may need to be controlled to prevent or reduce extremely lean HCCI operation that may produce high levels of carbon monoxide (CO) and hydrocarbon (HC). To do so, the routine may regulate desired air flow by adjusting the cold and hot throttle positions at 620. The desired air amount (des_air) may be computed from the desired operating conditions as below:

des_air=Fn_air(des_{—}Tq, N).

The control of hot and cold throttles to deliver the desired amount of air may be synchronized with the air-charge temperature control that, in turn, controls the start of combustion. Thus, adjustment of throttles may take into account the combustion timing and air flow from each stream. For example, once the split between the amount of air in the hot and cold streams has been determined, then the desired air amounts may be achieved by adjusting the hot and cold throttles based on the feedback from the combustion timing and actual air flow. An exemplary feedback loop shown in FIG. 7 may be used to adjust throttle position.

Now referring to FIG. 7, a block diagram of an airflow control and throttle position regulation system for the hot stream control is shown, where the throttle position regulation system for cold stream is symmetric to the hot stream system, but not shown. As shown in FIG. 7, the flow of the cold air stream C in the intake manifold 744a may be controlled by the opening position of the cold throttle 716. The cold air flow may be monitored by the sensor 712. Similarly, the flow of the hot air stream H in the intake manifold 744b may be controlled by the opening position of the hot throttle 718. The hot air flow may be monitored by the sensor 714. The cold air stream C and the hot air stream H may be mixed in the manifold before the total flow enters the combustion chamber 710.

In the depicted embodiment, the feedback loop may be a proportional integral (PI) controller, for example. In some embodiments, the controller may be augmented with a first order filter to make the loop slower by dominating the throttle positioning dynamics and to filter possible measurement noise and induced air-flow oscillations. The error (air_error) that drives the PI controller may be the difference between the desired air flow des_air and the total (hot plus cold stream) air flow:

air_error=des_air−(MAF_{—}c+MAF_{—}h)

where MAF_c and MAF_h are the air flow of cold and hot streams measured by mass air flow (MAF) sensors 712 and 714, respectively. While measured values are illustrated in this example, the airflows may be measured, estimated, and/or combinations thereof.

In some embodiments, the desired position for the cold and hot throttles may be computed as the sum of several components. For example, the desired hot throttle position (tp_des_h) may be determined as below:

tp_{—}des_{—}h=tp_feedfor_{—}h+tp_{—}maf_feedback+tp_comb_feedback_h

where tp_feedfor_h is the feed-forward throttle position term, tp_maf_feedback is the feedback throttle position term derived from difference between desired air flow and the total air flow measure by MAF sensors, and tp_comb_feedback is the feedback throttle position term derived from combustion timing, each of which is discussed in more detail below herein.

The tp_feedfor_h may be computed from mapping data by correlating the throttle position to the hot and cold air-flows at a given operating condition as below:

tp_feedfor_{—}h=Fn_{—}tpff(N, des_air_hot, des_air_cold).

The tp_maf_feedback may be calculated as below:

Tp_{—}maf_feedback=(Kp+Ki/s)/(τs+1)*air_error.

### Where des_air_hot and des_air_cold are defined later in the text, Kp is the proportional gain, Ki is integral gain, s is Laplace operator, and τ is time constant.

The term, tp_comb_feedback is described in greater detail below.

Similarly, since the cold throttle control system is symmetric, the desired cold throttle position (tp_des_c) may be determined as below:

tp_{—}des_{—}c=tp_feedfor_{—}c+tp_{—}maf_feedback+tp_comb_feedback_{—}c

In some embodiments, the same feedback term tp_maf_feedback is used to drive both hot and cold throttles. The difference between the two streams is in the feed forward terms and the combustion feedback terms. The combustion feedback terms may have opposite signs.

Now, referring back to FIG. 6, the routine, at 622, adjusts combustion timing by, for example, increasing the opening of one throttle and decreasing the opening of another throttle, where the combustion timing may be determined by air temperature. For example, to advance combustion timing while reducing effects on total airflow, temperature of the initial charge may be increased by increasing opening of the hot throttle and decreasing opening of the cold throttle. Alternatively, to retard combustion timing while reducing effects on total airflow, temperature of the initial charge may be decreased by decreasing opening of the hot throttle and increasing opening of the cold throttle. The amounts of opening/closing may be related to maintain a desired total flow, for example.

In still another example, to increase total airflow while reducing effects on combustion timing, flow may be increased by increasing opening of both the hot and cold throttles in a specified proportion. Alternatively, to decrease total airflow while reducing effects on combustion timing, flow may be decreased by decreasing opening of both the hot and cold throttles in a specified proportion. Again, the relationship between the amounts of opening/closing may be related and/or adjusted to maintain a desired combustion timing, for example.

Note that while the above operations are for specific examples, both the combustion timing and total flow may be continuously varying, and actual adjustment of the throttles may include adjustments for both combustion timing and total flow.

In one example, the desired air temperature (des_T_air) may be determined to provide combustion timing appropriate for the given conditions such as torque, engine speed, etc. In one embodiment, the desired air temperature may be determined as below:

des_{—}T_air=Fn_{—}cwt(CWT)*Fn_air(des_{—}Tq, N)

where CWT is a cylinder wall temperature which may be estimated from the past values of torque, operating mode (SI/HCCI) and engine coolant temperature (ECT). In steady state, an ECT changing from 340 to 366 deg K may change the air-charge and, thus, the absolute temperature of the air at IVC by about 6% (that is, by about 15 to 20 deg K). In one example, the function Fn_cwt(CWT) may include a correction to take this effect into account.

Given measured air temperatures of the hot T_{H} and cold T_{C} streams, with T_{H}>T_{C}, the desired amount of air determined above at 620, and the desired air temperature, the fractions of air from hot and cold streams may be determined as below:

des_air_cold=des_air×max{0, (Th−des_{—}T_air)/(Th−Tc)}

des_air_hot=des_air×mas{0, (des_{—}T_air−Tc)/(Th−Tc)}

The desired combustion timing may be achieved by adjusting the air flow of both hot and cold streams through the throttle position correction. Various measures of combustion timing may be used for error term, and in one embodiment, location of peak pressure (LPP) is used as a combustion timing variable. Desired location of peak pressure (des_LPP) may be computed as below:

des_{—}LPP=Fn_air(des_{—}Tq, N).

Then an error signal may be formed as the difference between the measured and the actual location of peak pressure. The combustion feedback term for the throttle positions shown in FIG. 7 may be a filtered PI of the LPP error:

tp_comb_feedback=(K_{pcomb}+K_{icomb}/s)/(τ_{comb}s+1)×(LPP−des_{—}LPP)

where the subscript “comb” for the feedback controller parameters stands for combustion. In one embodiment, the filter time constant τ_{comb} may set to equal to 3 engine cycles. The proportional and integral gains K_{pcomb} and K_{icomb} may be adjusted experimentally or in simulations.

Alternatively, a location of 50% mass fraction burned (L50) may be used as measure of combustion timing. In this case, error term may be determined by replacing LPP with L50 in above equations.

Thus, the feedback term from combustion for cold and hot throttle positions may be determined as:

tp_{—}com_feedback_{—}c=−tp_comb_feedback

tp_comb_feedback_{—}h=tp_comb_feedback.

In general, FIG. 6 provides one example method for coordinated control of air charge and cylinder temperature or combustion timing in HCCI engines. In this approach, the cylinder air-charge may be regulated to the desired value by adjusting both throttles in the same direction (e.g., opening, or closing) proportionately to the MAF error while the appropriate combustion timing is achieved by increasing the opening of one throttle and decreasing the opening of another throttle (e.g., adjusting the throttles in different directions). In one embodiment, the adjusting of throttle positions is based on a measure of combustion timing, which provides control of combustion in HCCI mode. On the other hand, when desired air temperature is achieved but total air flow needs to be changed, the desired air flow can be obtained by varying the opening of both hot and cold throttles based on feedback from mass air flow sensors and/or combustion feedback. In this way, coordination of the throttles in HCCI mode can provide appropriate control of air temperature, combustion timing and air-fuel ratio. Thus, it is possible to reduce fuel consumption and emissions.

For example, in one embodiment, a substantially constant total air flow may be desired in response to a torque demand or other engine operating conditions (such as desired engine torque, engine speed, air fuel ratio, etc.) To achieve appropriate air temperature for the desired combustion timing, the air flow in one stream may be increased by increasing its throttle opening while the air flow in another stream may be decreased by decreasing its throttle opening by a related amount. The sign of the combustion timing feedback error may determine the decrease and increase of flow in each stream. In this way, the temperature in the air flow entering the cylinder can be adjusted to achieve appropriate combustion timing when two streams with different temperatures are mixed together, while also maintaining the desired air flow. In another example, both the total amount of flow and combustion timing may be adjusted, again by coordinated adjustment of both throttle openings.

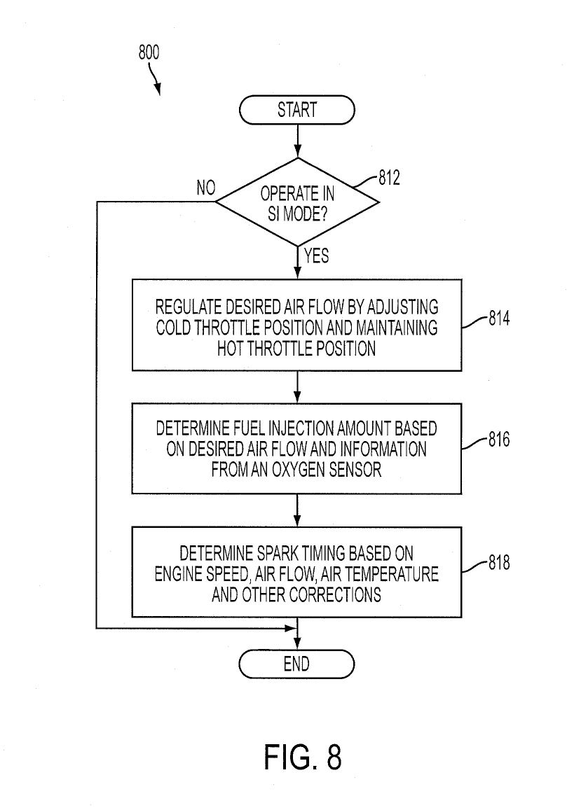

FIG. 8 illustrates an exemplary routine 800 which controls combustion through throttle positions in SI mode. Beginning at 812, the routine determines whether the engine is operating in SI mode. If the answer is no, the routine may end. If the answer is yes, the routine proceeds to 814 to regulate desired air flow by adjusting cold throttle and maintaining hot throttle position at a substantially constant position or a relatively small opening position to maintain temperature of the hot airflow in anticipation of a transition to HCCI mode. In SI mode, the cam profiles may be switched so that the valve lifts may be similar to those shown in FIG. 5. In the depicted embodiment, the hot-stream valve lift may be smaller in order to reduce the amount of hot air entering the cylinder. Further, it may not be completely disabled to provide a small leakage and keep the air temperature in the port approximately equal to that of the hot air-stream.

In SI mode, the hot-stream air flow may provide only a small contribution to the total (e.g. less than 20%). In some embodiments, the hot throttle may be set to a nominal position that is a function of the operating conditions, i.e., hot throttle position may be substantially constant. Thus, the main air contribution may be provided by the cold stream and the cold throttle positioned may be determined as below:

tp_{—}des_{—}c=Fn_{—}tpsi_{—}c(des_{—}Tq, N)

tp_{—}des_{—}h=const.

tp_{—}des_{—}c=Fn_{—}tpsi_{—}c(des_{—}Tq,N)

Next, at 816, the routine determines fuel injection amount based on desired air flow and information from an exhaust oxygen sensor. In general, fuel delivery and spark timing in the SI mode may depend on the estimate of the cylinder air-charge. In one embodiment, it may be assumed that the air flow over the MAF sensor enters the cylinder without additional time lag, thus the air charge, air_chg may be determined as below:

$$air\_chg = {\int }_{cycle}^{ } ( MAF\_c + MAF\_h ) d t$$

Where MAF_c and MAF_h are the cold and hot air flows determined by MAF sensors in the cold stream and hot stream, respectively. The integral over the cycle can be approximately computed as

$$\frac{120}{( N \times m )} {\sum }_{i = 0}^{m - 1} MAF ( t - i )$$

where the m samples represent one full engine cycle. In one embodiment, m equals to 4, and N is the engine speed in revolutions per time.

For the stoichiometric operation in the SI mode, the fuel amount may be determined based on the air charge and feedback from an exhaust oxygen sensor such as a universal exhaust gas oxygen (UEGO) sensor readings:

$${m}_{finj} = \frac{1}{14.6} air\_chg - UEGO\_feedback$$

$$UEGO\_feedback = ( {K}_{pu} + \frac{{K}_{iu}}{s} ) ( \frac{1}{{AF}_{UEGO}} - \frac{1}{14.6} )$$

The UEGO feedback may include a PI controller based on the signal of the UEGO air-fuel ratio sensor. The end of fuel injection may be determined based on desired torque and engine speed as below:

eoi=Fn_{—}EOI_{—}si(des_{—}Tq, N)

Next, the routine, at 818, determines spark timing based on engine speed, air flow, air temperature and other corrections. In SI mode, spark timing may be determined based on engine speed and load (in this context, the normalized air-charge) and then adjusted for ACT, ECT, EGR, cam-timing, etc. When two streams including a hot stream are used, the air-charge temperature may not be close to ambient. The air-charge temperature may be computed from temperatures of the hot and cold air-streams. Thus, the air temperature and spark timing may be determined as below:

$$T\_air = \frac{MAF\_c \times {T}_{C} + MAF\_h \times {T}_{H}}{MAF\_c + MAF\_h}$$

$$spark = Fn\_mbt ( N , air\_chg ) + FN\_spark \_Tair ( T\_air ) + other\_corrections$$

In summary, FIG. 8 provides an example method to control the combustion in SI mode. In this approach, throttle position control on substantially only one stream may be used to achieve the desired air flow. The fuel injection may be controlled based on air charge and feedback from the exhaust oxygen sensor. The spark timing may be determined based on engine speed, air flow, air temperature and other corrections.

Because the engine may operate in HCCI mode in some conditions and in SI mode in other conditions, mode switching may be used. In one example, mode switching may be accomplished by controlling the hot and cold air flows through the transition phase and spark timing on the SI mode side to provide a smooth engine torque response.

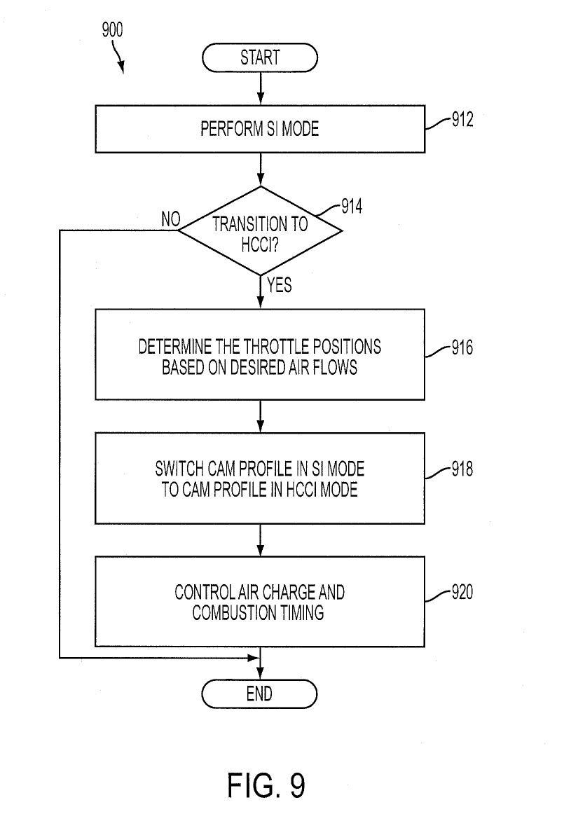

FIG. 9 shows an exemplary flow chart describing a control routine for performing transition from SI mode to HCCI mode. Beginning at 912, the combustion chamber is initially operating in SI mode, where it may be judged at 914 whether a transition to HCCI mode is required. If the answer is no, the routine may end or alternatively, the routine may continue monitoring the engine conditions where a transition is desirable. If the answer to 914 is yes, the routine, at 916, determines the throttle positions based on desired air flow. Specifically, during transitions from SI mode to HCCI mode, based on the current operating conditions, the amount of air-flow from each stream and the desired air-charge temperature may be estimated as described above. The throttles may be actuated using only the feed forward component while the two feedback components are switched off as below:

tp_{—}des_{—}h=tp_feedfor_{—}h(des_air_{—}h)

tp_{—}des_{—}c=tp_feedfor_{—}c(des_air_{—}c)

Because HCCI mode may require more air, this would in general require additional throttle opening. While still in the SI mode, the output engine torque may be limited to stay close to desired by retarding spark and running a leaner air-fuel ratio. That is, just before the transition, the engine is allowed to start running leaner than stoichiometric. The two actions may provide at least a 40% reduction in torque compared to operation with stoichiometric air-fuel ratio and MBT spark. Next, the routine, at 918, switches the cam profiles in SI mode such as those shown in FIG. 5 to HCCI mode such as those shown in FIG. 4. By doing this, the ratio of hot and cold air may be changed to provide a much higher air temperature (note the difference in valve profiles). Hotter cylinder wall temperature also may add heat to make sure the first HCCI cycle fires. Next, the routine, at 920, may control air charge and combustion timing using various strategies for HCCI mode as described herein. For example, after the transition (for example at the end of the first cycle), the feedback loops for throttle operation as described in the context of HCCI mode may be turned back on, i.e. the feedback components may be used to control the throttle position. The control strategy in accordance with FIG. 6 may be implemented.

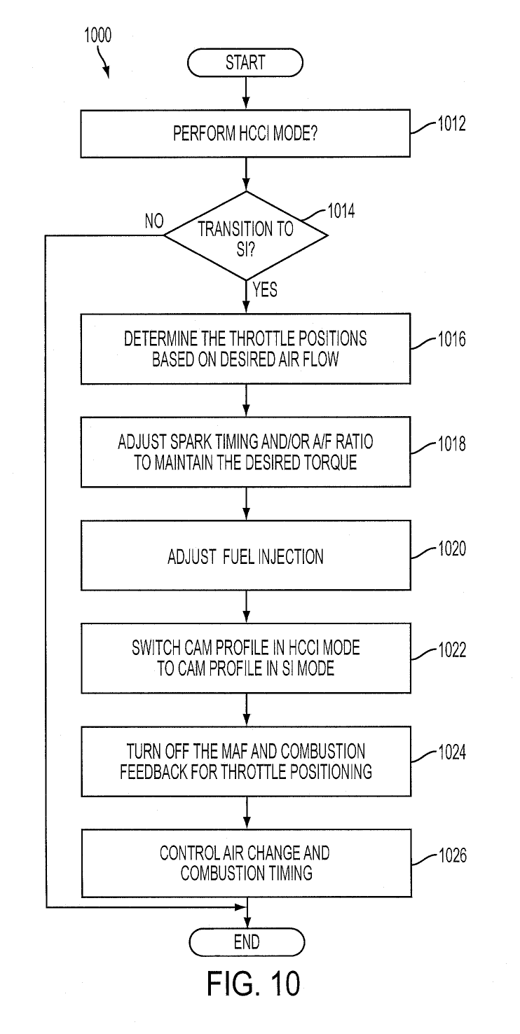

The transition from HCCI mode to SI mode may be a reverse of the transition from SI mode to HCCI mode. FIG. 10 shows an exemplary flow chart describing a control routine for performing transition from HCCI mode to SI mode. Beginning at 1012, the combustion chamber is initially operating in HCCI mode, where it may be judged at 1014 whether a transition to SI mode is required. If the answer is no, the routine may end, or alternatively, the routine may continue monitoring the engine operating conditions where a transition is desired. If the answer at 1014 is yes, the routine may determine in 1016 the throttle positions based on desired air flow. Specifically, the air flow in SI mode may be computed as described above with reference to FIG. 8. Next, the routine, at 1018, adjusts spark timing and/or air fuel ratio. The spark time may be retard and/or AF ratio may be adjusted to maintain the desired torque. Then, the routine, at 1020, adjusts fuel injection. If the current throttle positions (for HCCI mode) are still too high (e.g. by a factor of over 40%), then the throttle positions may have to be reduced to bring the post switch predicted air-charge within the limits while the torque and combustion timing still in HCCI mode. This may be accomplished by keeping the injected fuel at the desired level to maintain the torque, reducing desired air, and adjusting air temperature to control combustion timing. The last item may be facilitated by the closed control loop system still being active.

Next, the routine at 1022, switches a cam profile in HCCI mode such as the cam profile described in FIG. 4 to a cam profile SI mode such as the cam profile described in FIG. 5. Then, the routine, at 1024, turns off the MAF and combustion feedbacks for throttle positioning.

After the transition, the spark retard and/or AF ratio adjustment may be removed as the throttles are positioned to their normal SI mode operating positions. The TWC “resetting,” the rich AF operation needed to remove some of the oxygen stored in the catalyst, may be initiated as the AF ratio drops below 17:1 and the engine enters operating regions where higher NOx levels are generated. Next, the routine, at 1026, controls air charge and combustion timing using various strategies for SI mode as described herein.

Note that the example control and estimation routines included herein can be used with various engine and/or vehicle system configurations. The specific routines described herein may represent one or more of any number of processing strategies such as event-driven, interrupt-driven, multi-tasking, multi-threading, and the like. As such, various steps or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated steps or functions may be repeatedly performed depending on the particular strategy being used. Further, the described steps may graphically represent code to be programmed into the computer readable storage medium in the engine control system.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of operating an engine having at least one cylinder during a homogeneous charge compression ignition, comprising:
directing a first air stream to the cylinder via a first throttle;
directing a second, separate, air stream to the cylinder via a second throttle, said first stream at a higher temperature than said second air stream;
regulating a total air flow of a mixture of the first and second streams to a desired value by varying both openings of the first throttle and the second throttle in a same direction; and
adjusting compression ignition combustion timing by increasing an opening of the first throttle and decreasing an opening of the second throttle while maintaining the total air flow.

2. The method of claim 1 wherein varying the opening of the first and second throttles is based on information from a first mass air flow sensor in the first stream and a second mass air flow sensor in the second stream.

3. The method of claim 2 wherein varying the opening of the first and second throttles is further based on combustion timing.

4. The method of claim 1 wherein said total airflow is regulated to the desired value by increasing opening of both the first and second throttle.

5. The method of claim 1 wherein said total airflow is regulated to the desired value by decreasing opening of both the first and second throttle.

6. The method of claim 1 further comprising performing homogeneous charge compression ignition during a first condition, and spark ignition combustion during a second condition.

7. The method of claim 6 further comprising wherein said regulation is performed in response to a first and second mass airflow sensor.

8. The method of claim 1 wherein the adjustment of combustion timing is based on feedback from a measure of combustion timing.

9. The method of claim 8 wherein the measure is a location of peak pressure.

10. The method of claim 8 wherein the measure is a location of 50% of mass fraction burned.

11. A method of operating an engine having at least one cylinder during a homogeneous charge compression ignition, comprising:
directing a first air stream to the cylinder via a first throttle;
directing a second, separate, air stream to the cylinder via a second throttle, said first stream at a higher temperature than said second air stream;
increasing a total air flow of a mixture of the first and second streams increasing both openings of the first throttle and the second throttle;
decreasing the total air flow of the first and second streams decreasing both openings of the first throttle and the second throttle;
increasing temperature of said mixture by increasing opening of the first throttle and correspondingly decreasing opening of the second throttle while substantially maintaining the total air flow of the mixture; and
decreasing temperature of said mixture by decreasing opening of the first throttle and correspondingly increasing opening of the second throttle while substantially maintaining the total air flow of the mixture.

12. The method of claim 11 wherein said increasing and decreasing of the total air flow and said increasing and decreasing of temperature are based on information from a first mass air flow sensor in the first stream and a second mass air flow sensor in the second stream.

13. The method of claim 12 wherein said increasing and decreasing of the total air flow and said increasing and decreasing of temperature are further based on combustion timing.

14. The method of claim 11 wherein said increasing and decreasing of temperature is based on one of location of peak pressure and location of 50% of mass fraction burned.

15. A system for a vehicle, comprising:
an internal combustion engine having an intake system, an exhaust system, and at least combustion chamber;
a first intake manifold in the intake system wherein the first intake manifold includes a first throttle to control a flow of a first air stream and a heat exchanger to supply heat to the first air stream;
a second intake manifold in the intake system wherein the second intake manifold includes a second throttle to control a flow of a second air stream; and
a control system regulating a total flow of a mixture of the first and second streams to a desired value while maintaining a desired combustion timing during a homogeneous charge compression ignition operating mode by;
varying both openings of the first throttle and the second throttles in a same direction to regulate the total flow during said homogeneous charge compression ignition operating mode, and
increasing an opening of one throttle and decreasing an opening of the other throttle to maintain the desired combustion timing during said homogeneous charge compression ignition operating mode.

16. The system of claim 15 wherein the control system further adjusts combustion timing by increasing the opening of one throttle in the same amount as decreasing the opening of the other throttle.

17. The system of claim 15 wherein the control system further regulates the total air flow to the desired value by increasing opening of both the first and second throttles.

18. The system of claim 15 wherein the control system further regulating the total air flow to the desired value by decreasing opening of both the first and second throttles.
